(19) United States
(12) Patent Application Publication
(10) Pub. No.: US 2026/0104347 A1
(43) Pub. Date: Apr. 16, 2026

(54) ADHESION TESTING OF FERROMAGNETIC THIN FILM USING ELECTROMAGNETIC FORCES

(71) Applicant: Ford Global Technologies, LLC, Dearborn, MI (US)

(72) Inventor: Wilhelm Siebert, White Lake, MI (US)

(21) Appl. No.: 18/917,463

(22) Filed: Oct. 16, 2024

(51) Int. Cl. G01N 19/04

(52) U.S. Cl. CPC G01N 19/04

(57) ABSTRACT

An adhesion testing system includes an electromagnetic clamp and an adhesion test machine. The electromagnetic clamp is configured to generate an electromagnetic field to attach to a test sample having a thin film with ferromagnetic properties. The adhesion test machine is connected to the electromagnetic clamp and configured to apply a tensile force on the test sample with the electromagnetic clamp magnetically attached to the thin film.

### TECHNICAL FIELD

The present disclosure generally relates to systems and/or methods for testing adhesion forces of thin film having ferromagnetic properties.

### BACKGROUND

Testing adhesive strength of thin film coatings (e.g., 5-100 micrometer) can require multiple steps involving adhesives, fixtures, rollers, and/or specially designed devices to keep parallelism. Adhesion forces can be measured using various testing techniques, such as: shear force testing, peel force testing, and adhesive force testing.

### SUMMARY

In one form, the present disclosure is directed to a system including an electromagnetic clamp and an adhesion test machine. The electromagnetic clamp is configured to generate an electromagnetic field to attach to a test sample having a thin film with ferromagnetic properties. The adhesion test machine is connected to the electromagnetic clamp and configured to apply a tensile force on the test sample with the electromagnetic clamp magnetically attached to the thin film.

In one form, the present disclosure is directed to a system including a sample holder, an electromagnetic clamp, and an adhesion test machine. The sample holder has non-ferromagnetic properties and is configured to receive a test sample having a thin film with ferromagnetic properties. The electromagnetic clamp is configured to generate a magnetic force and at least a portion of the electromagnetic clamp is configured to attach to the thin film via the magnetic force. The adhesion testing machine is configured to apply a tensile force on the test sample with the electromagnetic clamp magnetically attached to the thin film.

### BRIEF DESCRIPTION OF THE DRAWINGS

FIG. 1 illustrates an example adhesion test system in accordance with the present disclosure;

FIG. 2 illustrates a portion of the adhesion test system in accordance with the present disclosure;

FIG. 3 is a flowchart of an example adhesion test routine in accordance with the present disclosure; and

FIG. 4 illustrates an example manufacturing process having an adhesive testing system in accordance with the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

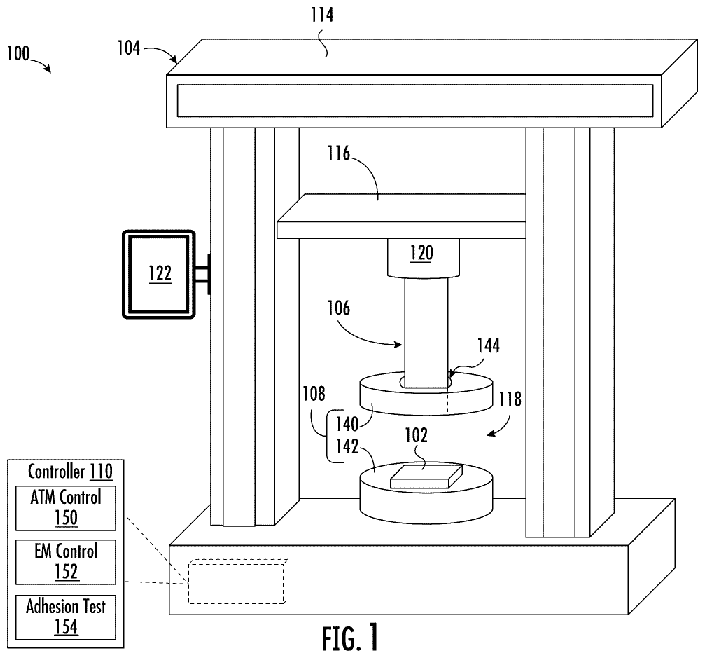

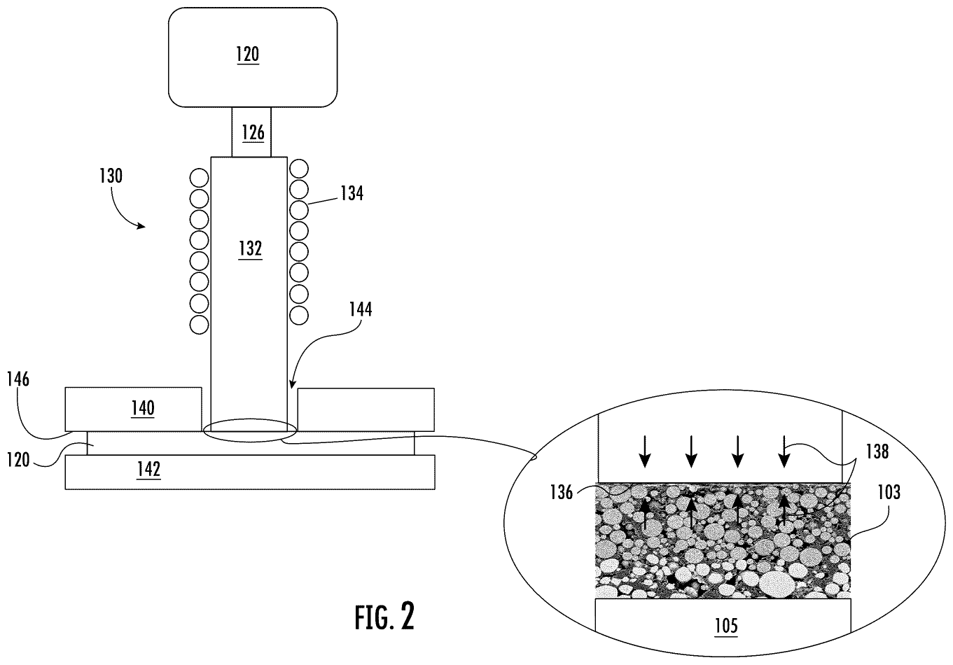

Referring to FIGS. 1 and 2, an adhesive testing system 100 is configured to perform a test, such as an adhesion test, to determine an adhesive force of a test sample 102 using electromagnetic forces to secure the test sample 102 to the system 100. The test sample 102 includes a thin film 103 having ferromagnetic properties (e.g., includes materials such as Iron (Fe), Nickle (Ni), and Cobalt (Co)) and adheres to a component 105. In a non-limiting example, the test sample 102 may be a sample of a battery cathode electrode having a thin film provided on a current collector as the component. In some applications, the thin film includes Ni, manganese (Mn), and Co, and therefore are containing Ni and Co as the ferromagnetic material. The thin film of the battery cathode electrode may be formed in various suitable ways, such as, but not limited to dry coat process, wet-coating process, and electrodeposition.

In one form, the system 100 includes an adhesion testing machine (ATM) 104, an electromagnetic (EM) clamp 106, a sample holder 108, and a controller 110.

The ATM 104 is configured to apply the tensile force on the test sample 102. Among other components, the ATM 104 includes a frame 114 forming the structural support, a cross head 116 to adjust a height of a gap 118 defined by the sample holder 108, and a load cell 120 to measure force exerted on the test sample 102. In some aspects, the ATM 104 further includes a human machine interface 122 configured to receive information from a user and provide information to the user. The HMI 122 is provided as a computing device having a touch screen, but may include other suitable interfaces, such as a mouse, keyboard, monitor, computer. In a non-limiting example, the ATM 104 may be a universal testing machine or other suitable testing machine configured to perform the adhesion test (e.g., a tensile test), and should not be limited to the ATM 104.

The EM clamp 106 is connected to the ATM 104 to be hanging freely with no pressure applied by the ATM 104. In one form, the EM clamp 106 is connected to the ATM 104 using an adaptor 126 (FIG. 2) that has a first end connected to cross head 116 and the other end opposite of the first end connected to the clamp 106.

The EM clamp 106 includes an electromagnet 130 having a core 132 and a coil 134 wrapped around the coil 134 (e.g., copper wire). The core 132 is made of magnetic steel or other suitable material to generate the EM field. In one form, the EM clamp 106 defines an attachment region 136 that may be part of the core 132 formed at an end of the core 132 or, more specifically, a distal end of the core 132. In another example, the attachment region 136 is part of a discrete component attachable to the electromagnet 130. The attachment region 136 is adapted to have a surface to abut and attach with the test sample 102, and specifically the thin film 103. For example, the attachment region 136 has a planar surface like the thin film 103. The shape of the core 132 may be configured in various suitable ways to accommodate larger or smaller attachment regions, but large enough to create the EM field suitable for generating a magnetic force to secure the attachment region 136 and the thin film 103 to each other, as represented by arrows 138.

The sample holder 108 is configured to support the test sample 102, and is defined of non-ferromagnetic properties. In one form, the sample holder 108 includes a first plate 140 and a second plate 142 positioned below the first plate 140. The first and second plates 140, 142 are moveable with respect to one another to define the gap 118 for the test sample 102. In a non-limiting example, in the illustrated example, the cross head 116 of the ATM 104 is operable to move the position of the first plate 140. It should be readily understood that in lieu of or in addition to the first plate 140, the system 100 may be configured to move the second plate 142. While the first and second plates 140, 142 are illustrated as planar discs, the first and second plates 140, 142 may have other suitable shapes, and may be different from one another.

In one form, the first plate 140 defines an opening 144 to receive at least a portion of the EM clamp 106, and specifically, the attachment region 136 of the EM clamp 106. The second plate 142 receives and supports the test sample 102, so that the test sample 102 is arranged between the first and second plates 140, 142, and the attachment region 136 and a bottom surface 146 of the first plate 140 are aligned to contact the thin film 103.

The controller 110 is configured to perform the adhesion test by, for example, aligning the test sample 102, generating the EM field, and providing the tensile force to measure the adhesive properties of the thin film 103. In one form, the controller 110 includes an ATM control 150, an EM control 152, an adhesive test control 154. While the controller 110 is illustrated as one controller, the controller 110 may be implemented using multiple controllers, and should not be limited to a single controller.

In one form, the ATM control 150 is configured to control operation of the ATM 104 during the adhesion test. In a non-limiting example, the ATM 104 is configured to: control movement of the cross head 116 with respect to position (e.g., positioning the sample holder 108 with respect to the test sample 102) and/or to speed (e.g., control strain applied to the test sample 102); and if applicable, provide test results using, for example, HMI 122.

The EM control 152 is configured to apply power to the EM clamp 106 to generate the EF field and turn-off power to the EM clamp 106 to turn-off the EM field. In one form, the EM control 152 is configured to provide adjustable power to the coil 134 of the EM clamp 106 to control the strength of the EM field and thus, the magnetic force for attaching the EM clamp 106 to the test sample 102. The magnetic force between the thin film 103 and the attachment region 136 should be higher than the force between the thin film 103 and the component 105 (e.g., current collector). In some forms, the magnetic force may be based on various factors, such as but not limited, the amount of ferromagnetic particles provided in the thin film 103 coating and/or the thickness of the thin film 103. In some aspects, the EM control 152 uses information from a sensor (e.g., a hall effect sensor) to monitor strength of the EM field to increase/decrease the electric current to the coil 134 to increase/decrease the magnetic force.

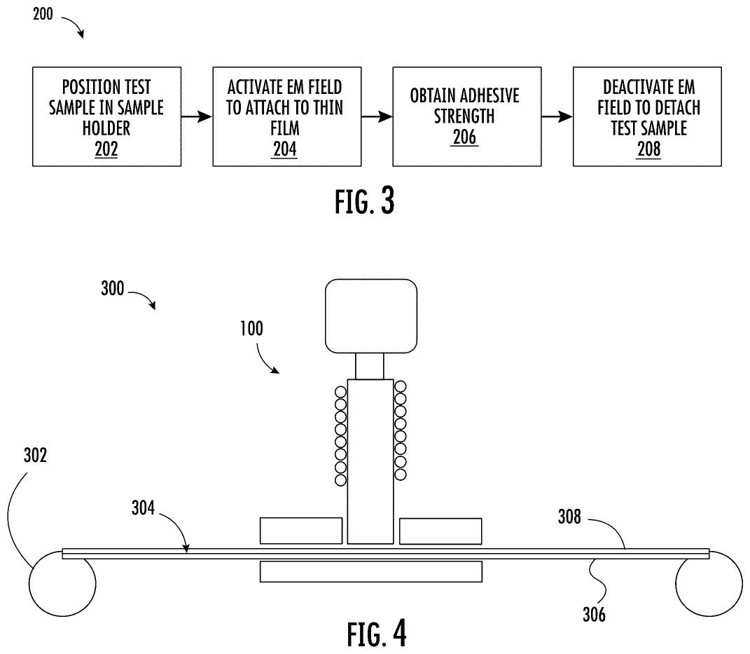

Using the ATM control 150 and EM control 152, the adhesion test control 154 executes the adhesion test for determining an adhesive force of the thin film 103 using the EM clamp 106 to attach the test sample 102 to the sample holder 108. Referring to FIG. 3, an example adhesion test routine 200 for the adhesion test control 154 is provided. With the test sample 102 placed in the sample holder 108, and specifically, on the second plate 142, the adhesion test control 154 holds position of the test sample 102, at operation 202. For example, using the ATM control 150, the first and second plates 140, 142 are positioned to contact the test sample 102 and have the sample holder 108 apply a rest force (e.g., a normal force) on the test sample 102 using at least one of the first plate or second plate 140, 142.

At operation 204, the adhesion test control 154 activates the EM field to attach the thin film 103 to the EM clamp 106 and thus, the ATM 104. For example, using the EM control 152, the adhesion test control 154 activates the EM field by applying power to the coil 134. In some variations, the EM control 152 monitors strength of the EM field to generate requisite magnetic force, and adjusts the electric current to the coil 134 if necessary.

At operation 206, with the thin film 103 attached and the EM field still active, the adhesion test control 154 obtains adhesive strength of the thin film 103 on the component 105. For example, the adhesion test control 154 performs the adhesion test using the ATM control 150 to obtain the adhesive strength of the thin film 103. With the EM field active, the test sample 102 is secured or, in other words, gripped between the first and second plates 140, 142 of the sample holder 108. Using the cross head 116, a tensile force is applied to the test sample 102 to stretch the test sample 102. The tensile force may be applied perpendicularly from the first plate 140, perpendicularly from the second plate 142, or both from the first plate 140 and the second plate 142. In some aspects, the adhesion test control 154 is configured to apply a requisite amount of tensile force on the thin film 103 measured by the load cell 120 for a selected period of time. The adhesion test may be configured in various suitable ways and should not be limited to the example provided herein. For example, the tensile force may be applied periodically or is applied until there is deformation.

At operation 208, once the adhesion test is complete, the adhesion test control 154 deactivates the EM field to detach the EM clamp 106 from the test sample 102. In a non-limiting example, the test results may be stored by at least one of the controller 110 or a remote server. The results may also be displayed by the HMI 122. It should be readily understood that the adhesion test control 154, may be configured in other suitable ways using the EM clamp 106 to grip the test sample 102, and should not be limited to the example provided herein.

In some applications, the system 100 of the present disclosure may be integrated with a manufacturing process employed for the product having the thin film 103. Referring to FIG. 4, in a non-limiting example, a battery cathode manufacturing system 300 includes a conveyor system 302 for transporting the cathode 304 having a current collector 306 (e.g., aluminum foil) with thin film 308 deposited thereon. The system 100 is arranged to test the adhesion strength of the thin film 308 as described herein, and the results may be employed by a manufacturing process controller to adjust a manufacturing parameter of the manufacturing process. For example, if adhesion is too low, additional time may be needed to dry the thin film 308 on the current collector 306, and thus, the temperature of an oven employed for drying cathode 304 may be increased or a speed of the conveyor system 302 may be reduced. While the integration of the system 100 is described with respect to a battery cathode manufacturing process, the system 100 may be integrated with other manufacturing processes.

The system 100 of the present disclosure employs magnetic forces to secure the test sample 102 to the sample holder 108 allowing the test sample 102 to be easily tested and removed without using a foreign material to secure the test sample 102 to the sample holder 108. The system 100 may further increase or decrease the magnetic force securing the test sample 102 to the sample holder 108 by adjusting the electric current to the coil 134 without having to remove the test sample 102 from the sample holder 108. These and other features may be realized by the system 100 of the present disclosure.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

In this application, the term “controller” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium (e.g., non-transitory computer-readable storage medium). The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a USB, CD, a DVD, or a Blu-ray Disc).

The apparatuses and methods described in this application may be partially or fully implemented by a special purpose computer created by configuring a general-purpose computer (e.g., computing device) to execute one or more particular functions embodied in computer programs. The functional blocks, flowchart components, and other elements described above serve as software specifications, which can be translated into the computer programs by the routine work of a skilled technician or programmer.

What is claimed is:

1. A system, comprising:
an electromagnetic clamp configured to generate an electromagnetic field to attach to a test sample having a thin film with ferromagnetic properties; and
an adhesion test machine connected to the electromagnetic clamp and configured to apply a tensile force on the test sample with the electromagnetic clamp magnetically attached to the thin film.

2. The system of claim 1, further comprising a sample holder configured to receive and hold the test sample, the sample holder being defined of non-ferromagnetic properties.

3. The system of claim 2, wherein the sample holder includes a first plate and a second plate positioned below the first plate, and the adhesion test machine is configured to move the first and second plates with respect to one another.

4. The system of claim 3, wherein the first plate defines an opening and at least a portion of the electromagnetic clamp extends through the opening to contact the thin film and magnetically attach to the thin film in response to the electromagnetic field.

5. The system of claim 1, wherein the electromagnetic clamp includes an electromagnet having an attachment region at one end to connect to the test sample and being connected to the adhesion testing machine at the other end opposite of the attachment region.

6. The system of claim 5, further comprising a sample holder configured to receive and hold the test sample, the sample holder being defined of non-ferromagnetic properties, wherein the sample holder defines an opening and the attachment region extends through the opening to contact and magnetically attach to the thin film in response to the electromagnetic field.

7. The system of claim 1, further comprising a controller configured to:
provide power to the electromagnetic clamp to generate the electromagnetic field,
apply the tensile force to the test sample to measure adhesive force, and
turn-off power to the electromagnetic clamp to detach the electromagnetic clamp from the test sample.

8. A manufacturing system, comprising:
an electrode manufacturing line generating an electrode and including a conveyor to move the electrode, the electrode a having a thin film with ferromagnetic properties; and
the system of claim 1 arranged along the conveyor to receive the electrode.

9. The manufacturing system of claim 8, wherein the electrode manufacturing line includes a controller configured to adjust a manufacturing parameter based on a result of the adhesion test.

10. A system, comprising:
a sample holder having non-ferromagnetic properties and configured to receive a test sample having a thin film with ferromagnetic properties;
an electromagnetic clamp configured to generate a magnetic force and at least a portion of the electromagnetic clamp being configured to attach to the thin film via the magnetic force; and
an adhesion testing machine configured to apply a tensile force on the test sample with the electromagnetic clamp magnetically attached to the thin film.

11. The system of claim 10, wherein the sample holder includes a first plate and a second plate positioned below the first plate, and the first and second plates are moveable with respect to one another using the adhesion testing machine.

12. The system of claim 11, wherein the first plate defines an opening and the at least the portion of the electromagnetic clamp extends through the opening to contact the thin film of the test sample and magnetically attach to the thin film in response to the magnetic force.

13. The system of claim 10, wherein the electromagnetic clamp includes an electromagnet having an attachment region at one end to connect to the test sample and connected to the adhesion testing machine at the other end opposite of the attachment region.

14. The system of claim 13, wherein the sample holder defines an opening, and at least the attachment region of the electromagnet extends through the opening to contact the test sample.

15. The system of claim 10, further comprising a controller configured to:
provide power to the electromagnetic clamp to generate the magnetic force,
apply the tensile force to the test sample to measure adhesive force, and
turn-off power to the electromagnetic clamp to detach the electromagnetic clamp from the test sample.

16. A manufacturing system, comprising:
an electrode manufacturing line generating an electrode and including a conveyor to move the electrode, the electrode having a thin film with ferromagnetic properties; and
the system of claim 10 arranged along the conveyor to receive the electrode at the sample holder.

17. The manufacturing system of claim 16, wherein the electrode manufacturing line includes a controller configured to adjust a manufacturing parameter based on a result of the adhesion test.
